(19) United States
(12) Patent Application Publication
(10) Pub. No.: US 2014/0324716 A1
(43) Pub. Date: Oct. 30, 2014

(54) Method and system for deterring product counterfeiting

(71) Applicants: Carolina Haber Florencio, Redmond, WA (US); Dinei Afonso Ferreira Florencio, Redmond, WA (US)

(72) Inventors: Carolina Haber Florencio, Redmond, WA (US); Dinei Afonso Ferreira Florencio, Redmond, WA (US)

(21) Appl. No.: 13/872,155

(22) Filed: Apr. 29, 2013

(51) Int. Cl. G06Q 30/00

(52) U.S. Cl. CPC G06Q 30/0185
USPC 705/318

(57) ABSTRACT

The claimed subject matter relates to an architecture to produce disincentives to wearing counterfeit or stolen merchandise in public. In particular, the architecture utilizes a unique identifier associated with each unit of the product, and provides both a registration channel for receiving ownership registration and a verification channel to receive requests for verification. By way of illustration, the architecture can include associating a brand logotype that includes unique markings with each unit of a product, a private web service where the retailer may upload customer information at the time of sale, and a publicly available web service, where a third party may inquire about the ownership of a product containing a certain unique identifier.

The invention relates to the authentication of merchandise units, and in particular, to authentication after final purchase of merchandise units identified by unique identifiers.

### BACKGROUND OF THE INVENTION

Counterfeiting, the illegal manufacturing and selling of brand copyright-protected articles, poses a huge and still increasing threat to global businesses—including organizations in the life sciences, consumer products, media, apparel, luxury goods, and food and beverages industries. Likewise, stolen merchandise which is then resold through traditional or “parallel” distribution channels seriously affects trade market in general.

According to the U.S. Customs and Border Protection, the total domestic value of the fake goods seized in fiscal year 2010 was $188.1 million. That corresponded to an estimated manufacturer's suggested retail price totaling US$1.4 billion, if the products were legitimate.

According to U.S. Immigration and Customs Enforcement (ICE) Director John Morton, “The protection of intellectual property is a top priority for Homeland Security Investigations, as counterfeit products represent a triple threat by delivering shoddy and sometimes dangerous, goods into commerce, by funding organized criminal activities and by denying Americans good-paying jobs”. Trade in counterfeit and pirated goods poses significant threats to the innovation-based economies, including the US and Europe. According to the Organization for Economic Cooperation and Development, the value of counterfeit goods that crossed international borders in 2007 was more than $250 billion.

Major repercussions of these activities include of course loss of revenue for the enterprise, but undermine the trade market globally. It is threatening branding, intellectual property, and research and development. It might carry along also a negative impact on brand image when customers eventually realize they are not getting the quality of products they come to expect from the trademark or the quality label they thought they own. In other cases, particularly when relating to luxury goods, even when customers receive legitimate merchandise, their perception of value and uniqueness may be reduced when they see counterfeit merchandise in the hands of other consumers. Finally, counterfeiting and piracy also affect the labor market, as many jobs are lost as a consequence of these fraudulent activities.

Counterfeited merchandise may be inserted in the distribution channel at varied points. The state of the art already includes a number of methods that can be used to control or alleviate the introduction of fake merchandise on these legitimate channels. One problem that has not been satisfactorily solved is the distribution of fake merchandise though “secondary” channels, i.e., channels that, in essence, only sell fake merchandise, and, in many cases, with the buyer/consumer having full knowledge that the merchandise is not legitimate. For these cases, manufacturers can only find mild protection, by means of a number of techniques that produces tags or other devices which are hard to reproduce. This is, however, an incomplete and unsatisfactory solution. First, there is high cost in producing these hard-to-reproduce tags. Second, if a close enough version can be produced, this may be enough to many buyers. After all, many buyers may be fully aware of the nature of the fake merchandise. In such cases, the legitimate manufacturer is left with the high cost of producing such a tag, while the illegitimate manufacturer may get away with a lower cost tag. And third, if said tags are stolen, they cannot be differentiated from the legitimate ones at all.

Thus, there is need for improved technologies that provide disincentives for consumers to knowingly acquire fake merchandise.

FIG. 1 depicts a simplified standard process from a merchandise manufacturing to the merchandise selling, as illustrated with bold arrows. Brand Company 100 orders a limited series of objects, or items, to a manufacturer 105.

After production of object's series, manufacturer, using a means for transportation 110 (air freight, marine transport or by road), sends the object's series to a wholesaler 115 who is in charge to dispatch subset of object's series to various trusted retailer 125. Wholesalers use generally transportation by road (120) for delivery to retailer.

Finally, the retailer 125 sells the branded goods to a customer 130. Today, large distribution companies take in charge the objects from the manufacturer to the retailer. Thin arrows depict samples of counterfeited objects and different means to distribute these counterfeited objects to customers, as well as branded goods that are stolen before being sold. A counterfeiter 135 produces copies of branded goods and via a dishonest dealer 140 distributes said counterfeited branded goods directly to the customer 130 or re-injects them in the normal distribution chain with or without the complicity of a third party working in this normal distribution chain. Re-injection of counterfeited branded goods may be done at different levels of the distribution chain as the transit 110, the wholesaler 115, the distribution 120, or finally the retailer 125. So, even if a customer buys a branded good in a shop, he/she has no guaranty about the authenticity of said branded object. Likewise, branded goods stealing may be done at different levels of the chain by thief 145: in the manufacturer area 105 or in the distribution chain at the transit 110, the wholesaler 115, the distribution 120, the retailer 125, or, even the customer 130. Furthermore, the theft may be assisted or facilitated by one of the parties in the chain, or by an employee of said part. For example, a manufacturer may overproduce certain merchandise with intent to sell it through an unauthorized channel.

A customer 130 who buys this stolen branded good directly from thief 140 or 145 generally knows that the object has been stolen, or that is not legitimate. This willing customer of illegitimate merchandise constitutes one of the biggest challenges for counterfeiting prevention, and a key focus of the current invention.

Whatever the way looking at it, counterfeit and theft problems can't and won't be totally eliminated. So existing technology mostly consists in trying to keep them under control on the distribution and manufacturing channels. Existing technologies do that by raising the barriers to casual violations, and by requiring a concerted and even more complex effort by attackers. In the current invention, we describe a method to raise a barrier, or create an inconvenience, to the final customer of illegitimate merchandise. This has not been addressed by any of the existing technologies. With the use of the methods described in the present invention, even merchandise that was stolen directly from the production line can be later identified as have being illegally acquired, reducing its value for the (dishonest) consumer.

Conversely, by making illegitimate merchandise distinguishable from legitimate ones, we preserve revenue for the brand owner, and increase the value of the merchandise to the consumer, by making sure the value provided by the uniqueness of the product design is not diminished by the proliferation of unauthorized reproductions.

The scale of the threat is prompting new efforts by multinationals to stop, or at least curb, the spread of counterfeits. Steps have been taken to protect by law, which can be a disincentive for some potential violators of rights. Companies are also more and more pressuring governments to crack down on counterfeiting, trying to ensure a way to protect Intellectual Property.

There is a need to help brand companies to implement solutions based on strong prevention, detection, and response strategies and tactics.

As factories across the world gain experience with high-end manufacturing, counterfeits have become more sophisticated as well. Counterfeiters have become so proficient that it can take an expert to recognize a fake product. Even worse, some counterfeit merchandise may, actually, be produced at the same factory, with the same raw material, by the same machinery and personnel. They may, in fact, be identical in all practical aspects; except for they are illegally produced and no royalties have been paid.

This is one of the reasons why IT-based solutions are envisioned as great technological contributors in acting against counterfeiters, putting innovation to work to protect a global economy itself driven by innovation.

Some solutions using electronic tagging are being experimented today in specific industries. For instance, a company has developed an electronic pedigree software and provides the expertise to safeguard and secure the pharmaceutical supply chain. This pedigree system, based on a Radio Frequency Identifier (RFID) tag with a unique Electronic Product Code (EPC), tracks all the information about a product as it moves through the supply chain, from the manufacturer all the way to the point of sale. Although this methodology represents a step forward in the war against counterfeiting and theft, a potential limitation rises from the fact that the Pedigree itself could be read and possibly copied or imitated, and then used abusively by fraudulent parties until the illegal procedure is detected and acted upon.

Other existing technologies create and securely manage a digital Certificate of Authenticity that will be encrypted and uniquely bound to the corresponding product and its accompanying media—a certificate container—. This Certificate may integrate a mechanism for protecting its digital content against unauthorized copy and reproduction. This Certificate would be used to verify and hopefully guarantee the authenticity of a product through a process checking that there is a perfect match between a Product Identifier Code and information derived from its Certificate of Authenticity. This solution, and a number of related solutions, helps a legitimate customer to verify whether a certain product is authentic or not. Note, however, these techniques are useless in combating cases where the customer is willingly buying a counterfeit product. In such cases, the (dishonest) consumer already knows the product is not legitimate.

Other type of protection involves making hard-to-reproduce tags, and includes some of the most widely used techniques. Older techniques include from simple metallic logos, to holograms, but all these became increasingly easy to reproduce. More recent solutions include complex 3D materials that have unique signatures when read by a dedicated device, these signatures then signed with a digital certificate. Again, these solutions have very weak or no effectiveness against, for example, the case of a customer willingly buying counterfeit merchandise. In particular, even for technologies where the legitimacy could be verified after the purchase, the requirement of proximity to the tag and expensive readers prevents from subtle authenticity verification: the consent and knowledge of the owner of the merchandise is essentially required, making the process too intrusive.

Thus, none of the existing technologies satisfactorily addresses the problem of the dishonest consumer intentionally acquiring illegitimate merchandise, be it a stolen unit or an unauthorized reproduction.

### SUMMARY OF INVENTION

The following is a brief summary of subject matter that is described in greater detail herein. This summary is not intended to be limiting as to the scope of the claims.

Described herein are various technologies pertaining to provide means to verify the legitimacy of a product. One of the unique characteristics of these technologies is that it can be used to verify legitimacy even after the final purchase has taken place, and that it can be done without explicit consent by the owner.

In an exemplary embodiment, a serial number or unique identifier is associated with each instance of a legitimate product. An association between a legitimate purchaser of such a product and such unique identifier is performed at time of purchase, and made available for subsequent verification by the general public. In an exemplary embodiment, the association may be the name or a picture of the legitimate purchaser, recorded by the authorized retailer at time of sale. The unique identifier may be a tag containing a unique code, which is visibly displayed when such merchandise is used in public. The verification method may be performed by capturing a picture of that visible identifier, and visiting the manufacturer website to verify the legitimate owner of such merchandise.

For instance, a consumer called Mary Doe purchases a FancyProducts brand handbag at a legitimate retailer. The handbag has an associated unique identifier, say a wearable tag that visibly displays the bag's serial number, 12345. The (legitimate) retailer has secure access to the manufacturer site AuthRetailer.FancyProducts.com, and upon sale, associates the serial number 12345 to customer Mary Doe. Mary subsequently wears the handbag in public situations. A third party, interested in knowing whether or not the handbag is legitimate, reads or captures a picture of the serial number. Such third party, subsequently visits the public facing portion of the manufacturer website www.FancyProducts.com, and asks for the name of the owner of handbag number 12345. The site than informs such third party that the legitimate owner is Mary Doe, does confirming the legitimacy of the product.

Note that a counterfeit or even stolen product may look exactly like the legitimate one, and may display a serial number as well. However, the un-authorized seller has no means to update the site to reflect the name of the owner. Thus, any third party trying to verify the legitimacy of the merchandise will get clued in that the merchandise is not legitimate.

As described in more detail later, other aspects of the invention include alternate ways of displaying a unique identifier that is not a serial number, other ways of identifying the legitimate purchaser that do not include making his or her name public, and aspects to allow the consumer to subsequently transfer or gift the merchandise to a different user. It also includes extensions to usage during the manufacturing and distribution process.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates the simplified supply chain from a merchandise manufacturing to the merchandise selling, the distribution chain of counterfeited objects, as well as the distribution chain of stolen branded goods.

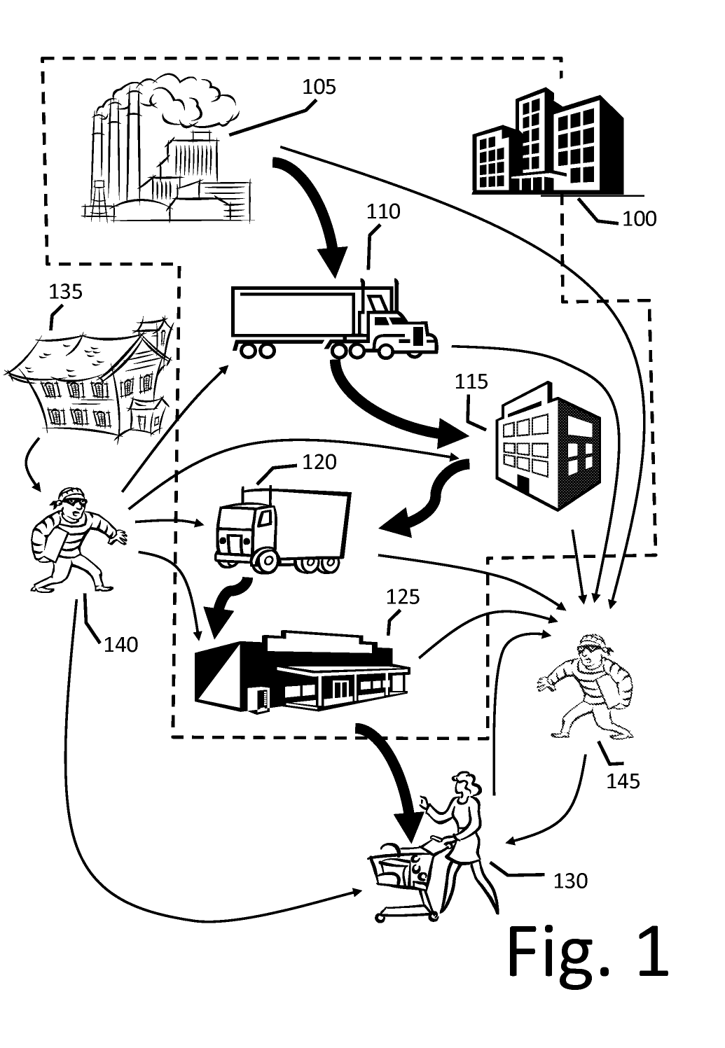

FIG. 2 illustrates possible designs for unique identifiers that can integrated into the product design, or on a tag.

FIG. 3 is a flow diagram that illustrates an exemplary methodology for associating a unique identifier with a customer.

FIG. 4 is a flow diagram illustrating the methodology to verify the likelihood of authenticity of the product bearing a unique identifier.

FIG. 5 is a block diagram representing an example of the main components and modules associated with practicing the invention.

### DETAILED DESCRIPTION

Various technologies pertaining to merchandise authenticity verification are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

Further advantages of the present invention will become apparent to the ones skilled in the art upon examination of the drawings and detailed description. It is intended that any additional advantages be incorporated herein.

According to the invention, an identifier and one or more entries in an authenticity database are associated to the branded goods to be checked for detecting counterfeiting or theft. The identifier can be associated with the merchandise at any stage in the distribution channel, as early as pre-manufacture, or as late as the final retailer.

The identifier referred in the previous paragraph can be re-utilized by a number of product units. In such case, the database may have as many entries as units sharing the same identifier. This may be a way of reducing the number of identifiers, particularly in cases where the database provides only confirmation of ownership, as later described in paragraph

However, in the preferred embodiment, each product unit caries a unique identifier.

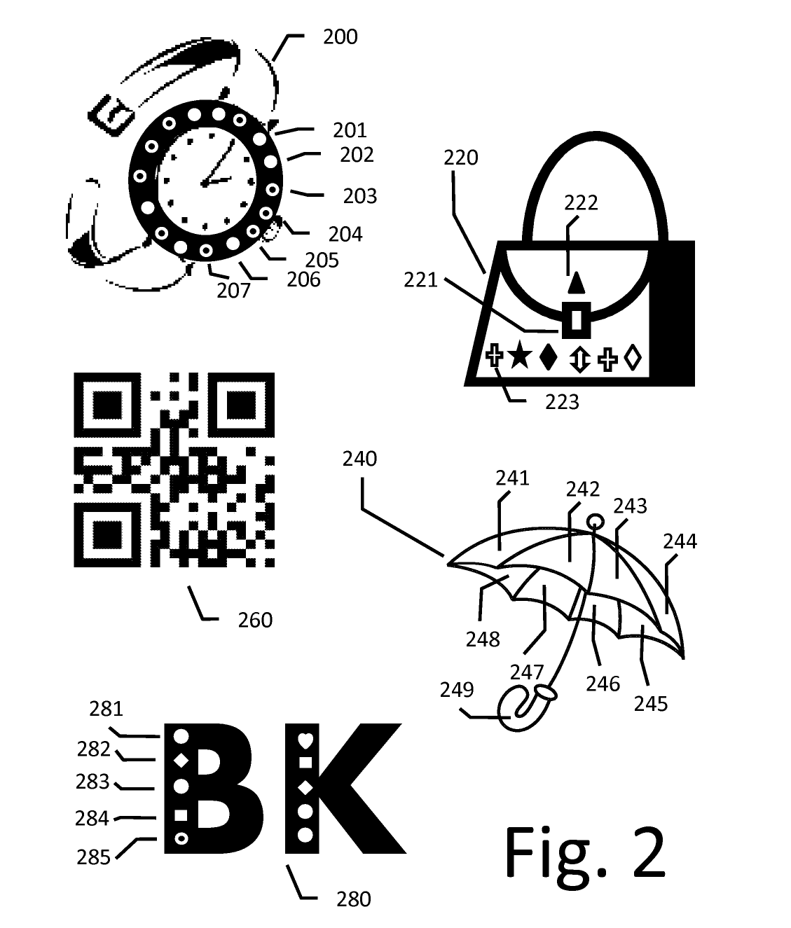

The identifier can be in a form of a tag, or can be incorporated directly in the product design. Traditional identifiers like barcodes, QR codes, digits, alphanumeric codes and the alike are all valid identifiers for the purpose of practicing this invention. More specifically, a handbag or other product could have, either attached on a tag, or directly incorporated into the product a number or code which uniquely identifies each unit of that product. Typically, however, barcodes and serial numbers and alphanumeric codes are not very fashionable as design elements. Thus, particularly for fashion items, other unique identifiers can be used. FIG. 2 illustrates a few instances of unique identifiers that are appropriate for the purposes of practicing this invention. Object 200 is a watch, which in its case has sixteen slots which can be painted in different colors (note that only slots 201, 202, 203, 204, 205, 206, 207, and 208 are explicitly labeled in the figure). Even if only two states are used (e.g., black and white), a dial with 16 slots would be able to uniquely encode up to 65536 units. If four colors or elements are used, over four billion unique codes exist. Object 220 represents a handbag, where the unique identifier was incorporated into the design, by inserting a combination of predefined elements into pre-defined position. More specifically, position 221, the latch, indicates a square design element; position 222 indicates a triangle element; position 223 indicates a cross. Each design element to the left of element 223 can be varied and used as a part of the unique identifier. Again, 16 types of objects in only 5 positions would provide 20 bits, and thus be enough to uniquely identify over one million objects. Drawing 240 represents yet another possible encoding. Here, an umbrella is used as the key representation, and could be a key element on the branding strategy. Each image segment, namely segments 241, 242, 243, 244, 244, 245, 246, 247, 248, and 249 is to be painted with a different color. Finally, note that it may be desirable to insert redundancy in the representation. More specifically, in some instances you may want to insert enough combinations that most combinations are not valid. This can be easily achieved by inserting more elements or more position into the coding. This would prevent the person trying to verify the authenticity from getting the wrong answer due to mistyping one color or character.

Still in relation to FIG. 2, element 280 illustrates incorporating the unique identifier on a brand logotype. In this example, the logotype 280 consists of two letters, B and K. Parts of the logotype are adorned with symbols. Each particular printing or embroidering of the logotype to contain a distinct combination of these symbols. In the example provided, each letter in the logotype 280 carries 5 symbols. The five elements in the first letter are marked as 281 282 283, 284, and 285, and consist of a circle, a diamond, a circle, a square, and a donut, respectively. Together with the 5 elements in the other letter, this could be enough to represent over 60 million if the elements are draw from a set of just 6 symbols.

Finally, 260 illustrates a QR code, which can also be used as a unique identifier. Other examples of barcodes include the Microsoft Tag, and other mechanisms that can easily be read by automatic means.

Note also that while visible identifiers are a preferred embodiment, non-visible identifiers can also be used, as long as they can be read by a third party. Examples include RFID, ultraviolet markers, digital watermarks, and others.

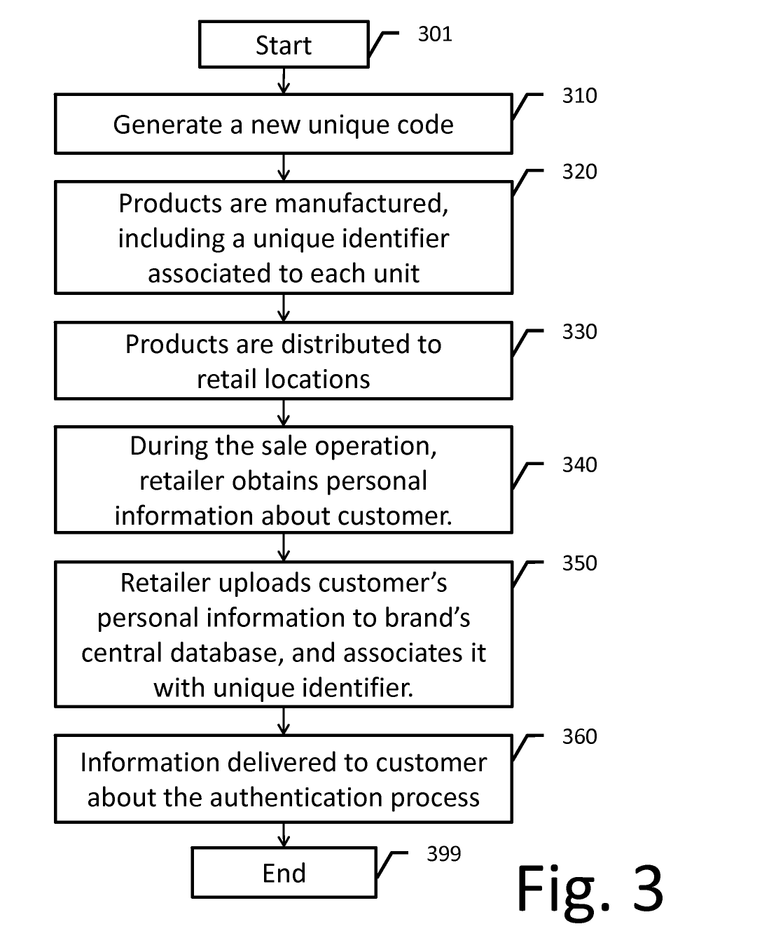

According to the invention, information about the legitimate owner of the product has to be uploaded to a database before public use of the product containing the unique identifier. This can be done in a number of manners. In a preferred embodiment, described in the next paragraph in association with FIG. 3, the uploading of such information is done by the retailer during the purchase process. Other embodiments include providing an authentication code for the user to upload the information herself, as well as automatic uploading based on information available at time of purchase. Information available at time of sale include data and location of purchase, customer name, zip code, and other information available or that can be obtained in conjunction with credit card, coupons, or other forms.

FIG. 3 presents an overview of the association recording process. In step 301 the process starts. In step 310 a new unique code is generated. The code may be as simple as a serial number, or much more elaborate, as, for example, a unique color image or drawing, as exemplified in conjunction with FIG. 2. In step 320, a product is manufactured, and a readable element is manufactured, containing the unique code. The readable element may be integral part of the product to be protected, or it may be an independent element to be later attached or integrated into the product. In step 330 the products are transported and/or distributed to the authorized retail locations. In step 340 the retailer obtains the required personal information about the buyer. In step 350, the retailer accesses the manufacturer database, and uploads said buyer's information, associating that particular info with the unique identifier of the product sold. In optional step 360, information is delivered to the client about the authentication process. Such information may include details about the personal data recorded in the database, details about which pieces of that information will be available to the public, and information about how the public may have access to that information. It may also include instructions on how to update or correct such information, including an access code or other required means. In step 399, the process of finishes.

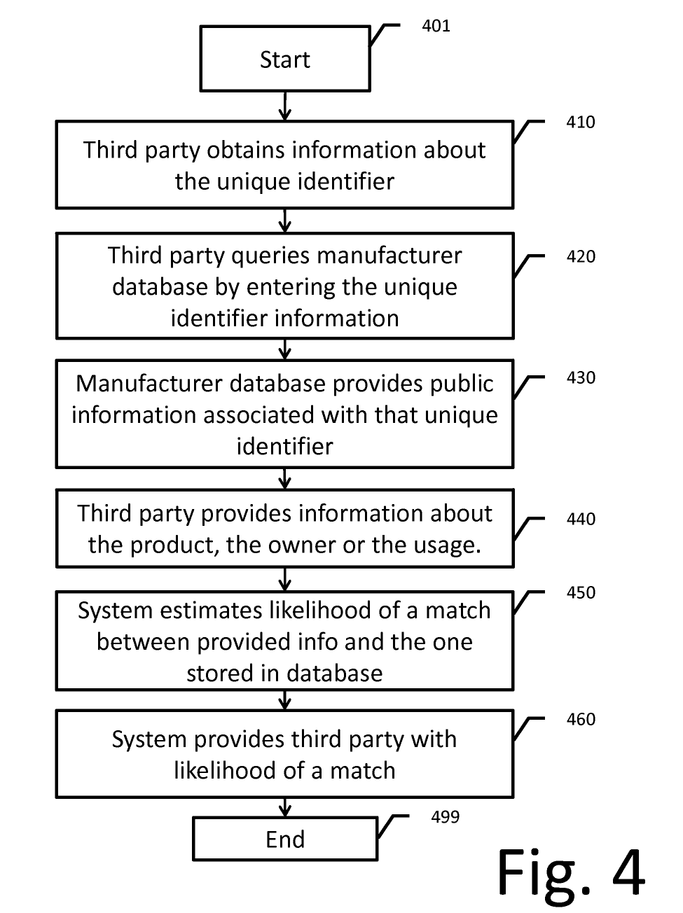

Is part of the assumptions regarding the invention that the customer will use the product in public. Is also part of the assumptions, that a customer that would otherwise be willing to wear illegitimate merchandise in public would be embarrassed if other people could easily verify that said merchandise is illegitimate. Is further part of the assumptions that such risk of embarrassment is sufficient, at least to reduce the number of people willing to buy or wear such fake merchandise. Thus, it is a key element of the invention to provide means for a third party to verify information about the legitimacy of a product. According to the invention, verification of legitimacy is done by verification of ownership. An example method for the verification process is described in the next paragraph, in association with FIG. 4.

FIG. 4 illustrates the verification process. In 401 the process starts. In 410, a third party obtains enough information to identify the unique identifier. This can be done, for example, by taking a picture of the object, as long as the picture includes enough information and resolution to be able to read the details of the identifier. A number of alternative methods for capturing the identifier may also be practical, depending on the type of identifier used. In step 420, the third party provides the necessary information about the unique identifier, and queries the manufacturer database. In a preferred embodiment, this is done by visiting the manufacturer website, navigating to the correct page, and entering enough information to identify the identifier. In 430, the website provides the third party with the public information associated with that identifier. The information may include whether or not the identifier is valid, and whether or not it was ever sold. More importantly, it may include personal information about the buyer or owner of the merchandise. This personal information may include a picture of the buyer, his or her name, his or her social site (e.g., Facebook) contact or url, their zip code, or any information enough for the third party to at least partially verify if a match with the bearer of the object is likely. At this point the process may end, as the third party has enough information to compares the public information provided in 430 with his or her own observations of the owner or the use of product with the unique identifier. Based on this comparison, the third party may reach a conclusion on the likelihood of the merchandise being authentic.

In another embodiment, the process continues, and, in optional step 440 the third party provides personal information about the product, or about the bearer or owner of the product, or about its usage. The system receives such information and, in optional step 450, compares such information with the corresponding information, public or private, stored in the database in association with the unique identifier. Based on that comparison, in step 460 the systems provides to the third party information about the likelihood of a match, or, in other words, the likelihood of the merchandise being authentic.

By means of example, if the public information provided by the database in 430 was a picture of the buyer, the third party could compare the picture with his own picture of the person wearing the product, and from that reach his own conclusions about the authenticity of the merchandise. Alternatively, the third party could in optional step 440 upload the picture of the owner, and the system could perform a face recognition based on the face information stored in the database, providing the likelihood of a match in step 450. A person skilled in the art will be familiar with face recognition software and technologies.

Privacy may be a concern, depending on the type of information provided by the manufacturer in step 430. Some users may not feel comfortable with their names being released to anyone snatching a picture of their handbag. We note, however, that by providing a picture of the person, no additional personal information is provided, since the third party had a picture of the person to begin with.

In another embodiment, as exemplified in steps 440 to 460, to preserve the privacy of the wearer, only confirmation is give. More specifically, the third party has to provide the unique code, along with a name, zip code, picture, or something else. The manufacturer site simply confirms or denies that the association is correct. A person skilled in the art of passwords and authentication will know techniques that can be used to alleviate a brute force attack, including Human Interactive Proofs, IP based throttling, etc.

Yet in another embodiment, the detection of the unique identifier is automatically done. More specifically, the third party provides, e.g., by uploading, a picture of the unique identifier, enough information for the manufacturer to recover the unique code, and thus reply with the associated data. In such cases, the unique identifier can be more subtle, e.g., a digital watermark or alike. Existing unique identifier satisfying this requirement for automatic detection include QR codes and Microsoft Tag. Other more fashionable designs can be easily developed and incorporated in a tag or as integral part of the product.

In Another embodiment, instead of the uniqueness of the identifier being visible, the unique information is imperceptibly embedded in an image or graphic by adding a digital watermark. Automatic detection is done by reading the embedded watermark, included in an image or graphics which is part of, or attached to, the product. In this case, the image is uploaded the manufacturer's server, and the watermarking extracted. In an alternative embodiment, the watermark detector is downloaded to a device. A person skilled in the art will recognize hundreds of ways of embedding and detecting (or reading) such a watermark.

In another embodiment, instead a graphical element, the unique identifier consists of a device that can be read by electromagnetic means. Examples include RFID and near filed communication devices.

The identification tag or identifier can be attached to the product at any point in the manufacturing and distribution process. If it is embedded in the product itself, it may, of course, have to be done during the manufacturing process. If it is simply attached to the device, it can be attached closer to the product being transferred to the final customer.

In any case, an association between the unique identifier and the current owner (e.g., the customer) has to be done before it can be verified by the third party.

In a preferred embodiment, the unique identifier is associated to the product during the manufacturing process. Then at the final, retail sale, the authorized reseller obtains some personal information about the customer, and associates that to the unique identifier. For example, the retailer may associate a picture of the customer to the specific identifier associated with the unit of merchandise said customer bought.

When the uploading of the customer information is done by the retailer, it will be necessary to authenticate the retailer or seller. A person skilled in the art will be familiar with a number of ways of authentication, including passwords, hardware tokens, etc. In a preferred embodiment, the manufacturer has a list of unique identifiers belonging to the retailer, and currently for sale. Even after authentication, the retailer is only authorized to upload associated with those unique identifiers. Depending on the way the technology is used, the retailer, after associating the customer with a unique identifier, may lose access to further modifications of that information.

In another preferred embodiment, the object containing the unique identifier is also associated with an authentication code that allows a customer to modify the information associated with the unique identifier after the purchase. For example, if the merchandise is bought as a gift to someone else, the retailer may leave not update any information to the site, or may associate the product with the purchaser. The purchaser, or final owner of the product, then uses such code to update the centralized database with the correct information of the final product user or owner.

In another preferred embodiment, such authentication code is a one-time use code. In a preferred embodiment, such code is hidden and becomes evident it was read. This can be achieved, for example, with scratch codes, as used in lottery tickets and the alike. In yet another embodiment, it is a one-time code, but a new one time code is automatically generated online whenever the last issued code is used.

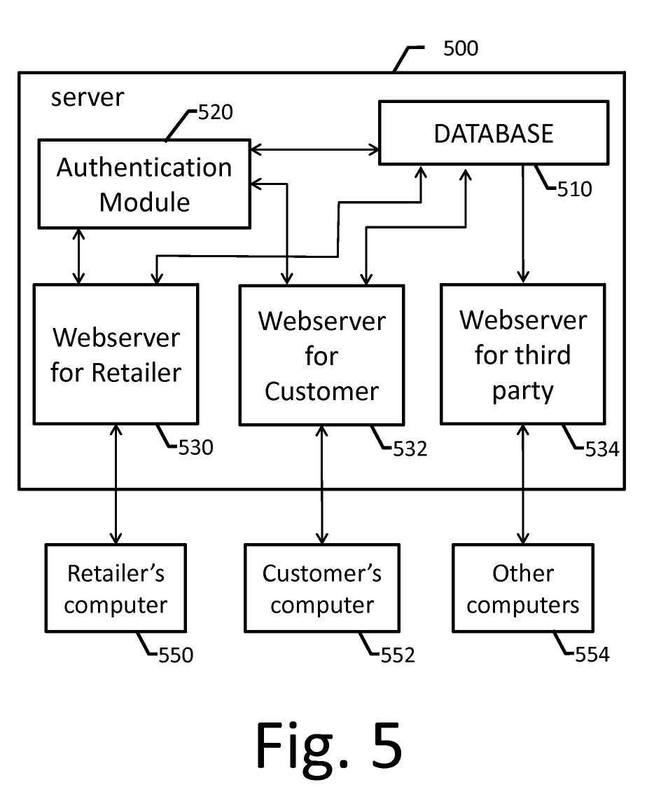

The information is stored in a database or other storage mechanism under the control of the manufacturer or brand owner. FIG. 5 illustrate a possible organization of such database, and means for accessing and modifying it. The server or servers 500 contain a storage unit where the database 510 is stored. The database contains all information regarding each unique tag, as explained elsewhere in this application. A retailer 550, or, more specifically, an agent or employee acting on behalf of the retailer, accesses the server 500 by connecting a local computer or other computing device 550 through a dedicated webservice 530. The webservice first authenticates the retailer by consulting the authentication module 520. The authentication process may be one of a number of authentications mechanisms, including but not limited to passwords, tokens, smartcards, SecurID, or other. Note also that this authentication can be persistent. A person skilled in the art will be familiar with a number of efficient authentication technologies. After being authenticated, the retailer has access to read and modify a number of entries in the database. More specifically, since each unique identifier has an entry in the database, and since the retailer has a number of these products for sale, there is one entry in the database corresponding to each unit of the products the retailer currently has in stock. The retailer has access to verify the status of these. More importantly, the retailer has access to modify these entries, for example, by associating it with the customer buying the merchandise. In a preferred embodiment, after the association is performed, the retailer may lose access to modifying such entry. In a preferred embodiment, the retailer may also print information about the association, and provide that to the customer. In one embodiment, the printed material contains enough information to allow the customer to subsequently updates or modify some or all of the information entered by the retailer. In another embodiment, the information printed is only enough to update said database entries when complemented with information contained in the product, or a tag attached to the product, or material included in the product packaging. Said complementary information may only be visible after a one-time operation. For example, it may include a code which is covered by ink, similar to technology sometimes used in lottery tickets and the alike; the user needing to scratch the surface to reveal the code. This is to avoid the risk that a rogue employee secretly copies such code, and subsequently make use of it. A person skilled in the art will immediately envision other mechanisms for accomplishing the same objective.

Still referring to FIG. 5, the Customer, after purchasing the product may optionally visit the manufacturer site. Using the credentials provided by the retailer for this purpose, the customer access the server 500 by connecting his computer or other computing device 552 to the server 500 though the webservice provided for customers 532. The webserver for customer 532 consults with the authentication module 520 and the database 510 to ascertain the legitimacy of the credentials provided. After authentication, the customer is given access to read, modify, or request a modification of a number of private and public information contained in the database, and associated with the unique identifier in the product purchased by the customer. For example, the initials, zip code, and other information may be directly modified. The manufacturer may decide to verify some information before updating. For example, it may require that the picture associated with the entry only be substituted with another picture where the customer can be easily identified. This would, for example, preclude the user to upload his cat's picture, or even some pornographic image. Finally, some information may not be allowed to be modified by the user, even if it's public. For example, the sale date may not be modified directly by the user.

Finally, and still referring to FIG. 5, a third party may also connect to the manufacturer server 500. It may do that by using his computer or other computing device 554. It connects to the webservice providing information to the general public. This webservice may include product information, or any other information. It also includes a means to access the public information stored in the database 510. More specifically, it provides means for the third party to provide information relating to a unique identifier. If the information provided is sufficient to identify the entry, the webserver 534 provides to the third party's computer 554 the public information associated with such an entry. For example, the public information may include such personal data as the product owner name, initials, zip code, address, picture, date and place of sale, etc.

In a preferred embodiment, the public information includes a link, url, or enough other detail as to give access to a public profile of the customer on a social site, e.g., Facebook, MySpace, LinkedIn in, etc.

In another embodiment, the public information includes a link to a site freely selected by the customer.

A person skilled in the art will appreciate that the particular kind of information to be considered public or private will depend on the application.

In another embodiment, there is an application or selection process before a customer can acquire certain merchandise. For example, a university may reserve a certain kind of product only for alumni. The product can then be identified with a unique identifier, wherein the unique identifier, when scanned or entered at an appropriate page at the university site will provide information about the specific alumni which the tag or unique identifier was issued to.

A similar process can be used for other selective groups. For example, a designer, tired of ugly people wearing his designs, may decide only beautiful people are allowed to use his creations. The selection or authorization process may include an interview at the store, or submitting a picture. Once a customer is approved, that is, authorized to wear that specific brand or design, a unique identifier is associated with him/her, or with each product to be worn by him/her. Note that this can be done either in advance or on the fly. More specifically, if each product already has a unique identifier, all those identifiers can be associated to a single person. Similarly, if the identifiers are produced after the association, many copies of the same identifier can be produced, and thus will all point to the legitimate owner.

In another embodiment, the user may participate in the design of the unique identifier himself. After the customer proposes the design, the design is checked for collision with existing designs, and, if no collision is found, the design is accepted.

Note that many aspects of the invention need one or more computing devices to perform various functions. These will include servers, personal computers, smartphones and other existing or future computing devices. Furthermore, as evident from the invention description, information needs to be transmitted between the devices. Such transmission may instant or delayed, and may be performed using the Internet, cellular phone network, or other communication medium. Similarly, each of these computing devices will need to run specialized software to perform the functions described herein. These may include database software, web servers, web browsers, encryption, and others. A person skilled in the art will be familiar with all these, and will easily be able to implement all parts of a system able to perform the teachings described herein.

What is claimed is:

1. A method for providing information regarding legitimate ownership of a product, the method comprising making each unit of merchandise uniquely identifiable, storing information about the corresponding legitimate owner of each unit in a database, and providing part or all of said information, upon request, to a third party, the method further comprising at least a manufacturing step, a registration step, and a verification step; wherein said manufacturing step includes at least:
Permanently attaching a first identifier to each unit of merchandise, said identifier being able to be uniquely identified by a third party without requiring knowledge or consent from the owner, nor contact or close proximity to the product;
and wherein said registration step includes at least:
associating one entry in said database with said first identifier;
storing, in association with said entry, information about the said first unique identifier;
storing, in association with said entry, enough personal information about the said legitimate owner or owners;
collecting from the legitimate owner, authorization to release all or part of said personal information to any third party that requests said personal information, and provides enough information about said first unique identifier;
and wherein said verification step includes at least:
a public-facing web service that receives verification requests, said request available to anyone interested;
receiving enough information about a second identifier to uniquely identify such second identifier among all identifiers stored in said database;
consulting the stored information regarding the legitimate owners of the product associated with said second identifier;
providing part or all the information stored about said owner.

2. The method of claim 1, wherein the identifier can be identified by visual methods.

3. The method of claim 2, wherein the identifier consists of a pattern or drawing, and the uniqueness is obtained by varying the color of different units or elements of the pattern.

4. The method of claim 3, wherein the identifier is integral part of the designer logo or the product design.

5. The method of claim 1, wherein the identifier consists of or contains a digital watermark.

6. The method of claim 1, wherein the identifier is unique to each unit of the merchandise.

7. The method of claim 6, wherein the identifier can be identified by visual methods.

8. The method of claim 7, wherein the identifier consists of a pattern or drawing, and the uniqueness is obtained by varying the elements or color of different units of the pattern.

9. The method of claim 6, wherein the information provided about the owner consists of a url, hyperlink, or other means to point at a website.

10. The method of claim 9, wherein the url points to a profile of the owner at a social site.

11. The method of claim 6, further comprising:
receiving information about a possible owner, said information being sufficient to determine whether a match with the registered owner is likely;
providing information about the likelihood of a match between the provided information and the one stored in the database as the legitimate owner.

12. A method for reducing the desirability of illegitimate merchandise, the method comprising making each unit of merchandise uniquely identifiable, storing information about the corresponding legitimate owner of each unit in a database, and providing, upon request from a third party, the likelihood of a match between the information provided by the third party, and the information stored in the database, the method further comprising:
associating each unit of merchandise with a unique identifier;
associating an entry in said database to each said unit of merchandise;
storing in association to said entry personal information about the legitimate owner of said unit;
receiving a authentication request from a third party, said authentication request including information about the unique identifier, as well as about a possible owner; wherein said information about the unique identifier is enough to uniquely identify said identifier, and wherein said information about the possible owner is enough to reduce the uncertainty about the match between the legitimate user information stored in the database and the provided information
returning, in response to said authentication request, the likelihood of a match between the information provided about the possible owner, and the corresponding information stored in the database entry associated with the provided unique identifier.

13. The method of claim 12, further comprising a means for the customer to access and update his own information stored in the site.

14. The method of claim 12, wherein a report is generated in association with the recording of the customer data, to be given by the retailer to the customer.

15. The method of claim 14, wherein said report contains a temporary password or other means to enable the customer to subsequently change or correct part or all of said stored information.

16. A method for providing information regarding legitimate ownership of a product, the method comprising making each unit of merchandise uniquely identifiable, storing information about the corresponding legitimate owner of each unit in a database, and providing part or all of said information, upon request, to a third party, the method further comprising at least a manufacturing step, a retail sale step, a registration step, and a verification step; wherein said manufacturing step includes at least:
permanently attaching a first identifier to each unit of merchandise, said identifier being able to be uniquely identified by a third party;
and wherein said retail sale step includes at least:
providing the buyer with an authentication code or device with each unit of merchandise,
and wherein said registration step includes at least:
authenticating the buyer by using the authentication code provided in the retail step;
associating one entry in said database with said first identifier;
storing, in association with said entry, information about the said first unique identifier;
storing, in association with said entry, enough personal information about the said legitimate owner or owners;
collecting from the legitimate owner, authorization to release all or part of said personal information to any third party that requests said personal information, and provides enough information about said first unique identifier;
and wherein said verification step includes at least:
a public-facing web service that receives verification requests, said request available to anyone interested;
receiving enough information about a second identifier to uniquely identify such second identifier among all identifiers stored in said database;
consulting the stored information regarding the legitimate owners of the product associated with said second identifier;
providing part or all the information stored about said owner.

17. The method of claim 16, wherein the identifier can be identified by visual methods.

18. The method of claim 17, wherein the identifier consists of a pattern or drawing, and the uniqueness is obtained by varying the color of different units or elements of the pattern, said identifier being integral part of the designer logo or product design.

19. The method of claim 16, wherein the identifier can be automatically read by computer.

20. The method of claim 19, wherein the identifier is a QR code, or another two dimensional barcode.
